(19) United States
(12) Patent Application Publication
(10) Pub. No.: US 2010/0275170 A1
(43) Pub. Date: Oct. 28, 2010

(54) Porting Analog Circuit Designs

(75) Inventors: Narayanasamy Subramanian, San Jose, CA (US); Richard P. Rouse, Sunnyvale, CA (US); Ziding Yue, Campbell, CA (US)

Correspondence Address: LNG/MoSys Joint Customer;C/O Luedeka, Neely & Graham, P.C., P.O. BOX 1871, Knoxville, TN, 37923, US

(73) Assignee: MOSYS, INC., Sunnyvale, CA (US)

(21) Appl. No.: 12/768,139

(22) Filed: Apr. 27, 2010

Related U.S. Application Data
(60) Provisional application No. 61/173,055, filed on Apr. 27, 2009.

(51) Int. Cl. G06F 17/50

(52) U.S. Cl. 716/3

(57) ABSTRACT

A computer-based method of converting an analog integrated circuit design from a source technology to a target technology, by providing a computer readable source schematic file and a computer readable source layout file for the analog integrated circuit design in the source technology, providing a computer readable technology transfer file that includes conversion tables between properties of the source technology and properties of the target technology, converting the source schematic file in the source technology to a target schematic file in the target technology with the computer using the technology transfer file, and converting the source layout file in the source technology to a target layout file in the target technology with the computer using the technology transfer file.

This application claims all rights and priority on prior pending U.S. provisional application Ser. No. 61/173,055 filed 2009.04.27. This invention relates to the field of analog integrated circuits (generally referred to as “circuits” herein). More particularly, this invention relates to migrating circuit designs from one process node to another, such as from a 65 nanometer design to a 45 nanometer design, or from a 1.2 volt process to a 1.0 volt process, or from one manufacturer to another. All such changes are individually and collectively defined as technology changes herein.

### FIELD

### Background

Analog integrated circuits are traditionally difficult to design. One reason for the difficulty in designing circuits is the sensitivity of the circuit to a given technology. Many different parameters in the specific technology play a role in the performance and robustness of the circuit. These parameters include, but are not limited to, resistance, capacitance, output conductance, current drive, threshold voltage, device variability, and device size.

Because of these sensitivities, a circuit is hand-tuned by a team of design engineers to a particular technology. In addition, each technology has its own design database building blocks, which tend to be incompatible one with another. Because of these challenges, migration of a circuit design from one technology to another is typically accomplished by redesigning the circuit from scratch. This prior art migration process 100 is depicted in FIG. 1.

The first step in a prior art migration 100 is an analysis of the target technology, as given in block 102. This typically requires about two weeks to accomplish. The second step is developing the logical schematic for the circuit, as given in block 104. This typically requires about six to eight weeks to accomplish. The third step is developing the physical layout for the circuit, as given in block 106. This typically requires about ten to twelve weeks to accomplish. However, problems are often detected at this point, which require some amount of recursion through the schematic and layout steps 104 and 106. Each recursion typically requires about five to seven weeks to accomplish. Finally, when the schematics and layout appear to be correct, the fourth step of validating the design is performed, as given in block 108. This typically requires about four to five weeks to accomplish. Thus, the entire migration process 100 typically requires as much as about eight months to perform.

What is needed, therefore, is a system for migrating a circuit design from one technology to another that requires less time than current migration processes.

### SUMMARY

The above and other needs are met by a computer-based method of converting an analog integrated circuit design from a source technology to a target technology, by providing a computer readable source schematic file and a computer readable source layout file for the analog integrated circuit design in the source technology, providing a computer readable technology transfer file that includes conversion tables between properties of the source technology and properties of the target technology, converting the source schematic file in the source technology to a target schematic file in the target technology with the computer using the technology transfer file, and converting the source layout file in the source technology to a target layout file in the target technology with the computer using the technology transfer file.

In this manner, the program routines for converting the schematic design and the layout design using the technology transfer file greatly decreases the amount of time that is required to covert the analog circuit design from the source technology to the target technology, and enables a true port of the design instead of merely migrating the design from source technology to target technology by manually redoing the design.

In various embodiments according to this aspect of the invention, the step of converting the source schematic file to the target schematic file includes converting source technology device names in the source schematic file to target technology device names in the target schematic file using the technology transfer file, and converting source device properties in the source schematic file to target device properties in the target schematic file using the technology transfer file.

In some embodiments the step of converting the source layout file to the target layout file includes selectively receiving as input and providing as output one of polygon based layout files, parameterized cell based layout files, and standard cell based layout files.

In some embodiments the technology transfer file includes a device name conversion table for converting device names in the source technology to device names in the target technology, and a property conversion table for converting functional device characteristics of the analog integrated circuit design in the source technology to functional device characteristics in the target technology that are associated with physical device characteristics in the target technology. In some embodiments the functional device characteristics include at least one of current drain-to-source versus voltage drain-to-source curves, positive power voltage scaling, transconductance, output conductance, voltage threshold, delay, leakage, capacitance, and resistance. In some embodiments the physical device characteristics include at least one of device length and device width.

In some embodiments the source technology includes a source node and a source foundry and the target technology includes a target node and a target foundry, and at least one of the source node and the target node, and the source foundry and the target foundry are different between the source technology and the target technology.

According to another embodiment of the invention there is described a technology transfer file disposed on a computer-readable medium, for converting an analog integrated circuit design from a source technology to a target technology. The technology transfer file includes a device name conversion table for converting device names in the source technology to device names in the target technology, and a property conversion table for converting functional device characteristics of the analog integrated circuit design in the source technology to functional device characteristics in the target technology that are associated with physical device characteristics in the target technology.

In various embodiments according to this aspect of the invention, the source technology includes a source node and a source foundry and the target technology includes a target node and a target foundry, and at least one of the source node and the target node, and the source foundry and the target foundry are different between the source technology and the target technology. In some embodiments the functional device characteristics include at least one of current drain-to-source versus voltage drain-to-source curves, positive power voltage scaling, transconductance, output conductance, voltage threshold, delay, leakage, capacitance, and resistance. In some embodiments the physical device characteristics include at least one of device length and device width.

According to yet another aspect of the invention there is described a computer-based apparatus for converting an analog integrated circuit design from a source technology to a target technology. An input receives and a memory stores a source schematic file and a source layout file for the analog integrated circuit design in the source technology, and a technology transfer file that includes conversion tables between properties of the source technology and properties of the target technology. Logic elements convert the source schematic file in the source technology to a target schematic file in the target technology using the technology transfer file, and convert the source layout file in the source technology to a target layout file in the target technology using the technology transfer file.

In various embodiments according to this aspect of the invention, the logic elements for converting the source schematic file to the target schematic file convert source technology device names in the source schematic file to target technology device names in the target schematic file using the technology transfer file, and convert source device properties in the source schematic file to target device properties in the target schematic file using the technology transfer file.

In some embodiments the logic elements for converting the source layout file to the target layout file selectively receive as input and provide as output one of polygon based layout files, parameterized cell based layout files, and standard cell based layout files.

In some embodiments the technology transfer file includes a device name conversion table for converting device names in the source technology to device names in the target technology, and a property conversion table for converting functional device characteristics of the analog integrated circuit design in the source technology to functional device characteristics in the target technology that are associated with physical device characteristics in the target technology. In some embodiments the functional device characteristics include at least one of current drain-to-source versus voltage drain-to-source curves, positive power voltage scaling, transconductance, output conductance, voltage threshold, delay, leakage, capacitance, and resistance. In some embodiments the physical device characteristics include at least one of device length and device width.

In some embodiments the source technology includes a source node and a source foundry and the target technology includes a target node and a target foundry, and at least one of the source node and the target node, and the source foundry and the target foundry are different between the source technology and the target technology.

### BRIEF DESCRIPTION OF THE DRAWINGS

Further advantages of the invention are apparent by reference to the detailed description when considered in conjunction with the figures, which are not to scale so as to more clearly show the details, wherein like reference numbers indicate like elements throughout the several views, and wherein:

FIG. 1 is a flow chart of the general prior art method to either design or migrate an analog circuit from one technology to another.

FIG. 2 is a flow chart of the method to port an analog circuit from a source technology to a target technology, according to an embodiment of the present invention.

FIG. 3 is a graph depicting a matching process between PMOS transistor properties in a source technology and a target technology, according to an embodiment of the present invention.

FIG. 4 is a graph depicting a matching process between NMOS transistor properties in a source technology and a target technology, according to an embodiment of the present invention.

FIG. 5 is a flow chart of a schematic porting process according to an embodiment of the present invention.

FIG. 6 is a schematic diagram of a circuit according to a source technology prior to schematic porting.

FIG. 7 is a schematic diagram of a circuit according to a target technology after schematic porting.

FIG. 8 is a flow chart of a layout porting process according to an embodiment of the present invention.

### DETAILED DESCRIPTION

The various embodiments of the present invention differ from the traditional circuit design migration techniques in that they implement a port of a source circuit design in a source technology to a target circuit design in a target technology, where various aspects of the port are automated and reusable. These aspects of the porting process—as opposed to a more general migration process as previously described—make the porting process much more time efficient.

It is noted that some porting of integrated circuits other than analog integrated circuits from one technology to another might be known. However, analog circuits have traditionally been viewed as being inapplicable to a porting process, for the reasons as previously mentioned. Currently, no one is efficiently porting analog integrated circuit designs to a target technology. Prior art migrations of analog circuits are conducted as though the circuit is being designed for the first time, without the use of preexisting design materials in the manner as described herein. The embodiments described herein overcome the limitations that have made it impractical to port an analog integrated circuit design. Thus, not only are the embodiments of the present invention novel in that they port analog integrated circuit designs, but they are also novel in the method that is used to port the designs.

### OVERVIEW

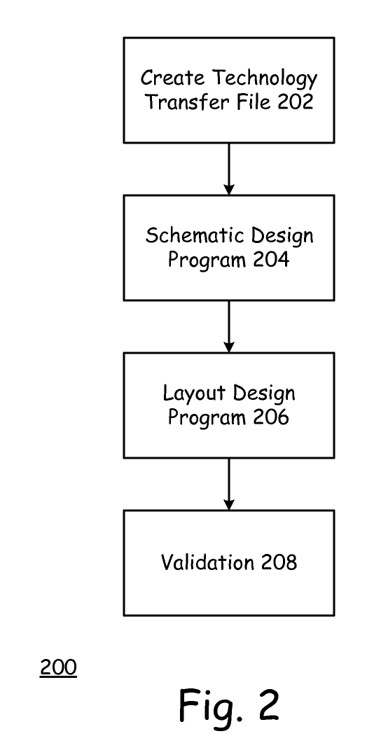

A general overview of the porting process 200 is depicted in FIG. 2. The first step is the creation of a technology transfer file, as given in block 202. Some of the differences between this step 202 and the technical analysis step 102 of the migration process 100 are described below. This step takes about two weeks to accomplish. The second step is to run a proprietary computer-based schematic design program, using two sets of input data, including (1) the technology transfer file, and (2) the standard schematic database for the source circuit design, as given in block 204. Some of the differences between this step 204 and the schematic development step 104 of the migration process 100 are described below. This step takes about one day to accomplish.

The third step in the process 200 is to run a proprietary computer-based layout design program, using two sets of input data, including (1) the technology transfer file, and (2) the standard layout database for the source circuit design, as given in block 206. Some of the differences between this step 206 and the layout development step 106 of the migration process 100 are described below. This step takes about one day to accomplish. The final step in the process 200 is to validate the design, as given in block 208. Some of the differences between this step 208 and the validation step 108 of the migration process 100 are described below. This typically requires about four to five weeks to accomplish. Thus, the entire porting process 200 typically requires as little as about seven weeks to perform, or in other words about twenty percent of the time required by the traditional migration process 100.

### Technology Transfer File

The technology transfer file identifies the key process design parameters that need to be ported, or in other words, that need to be adjusted in some manner from their values in the source circuit design so as to function properly in the target circuit design. These parameters typically include, but are not limited to, device names, layout layers, and key design rules. These are tabulated in a text format in the technology transfer file. As a part of this process, the source technology and target technology SPICE models are analyzed and device characteristics are compared. This analysis looks at SPICE parameters such as capacitance, resistance, transistor delay, drive current, gain, output conductance, and threshold voltage.

The analysis is performed with a proprietary computer-based program that investigates these parameters for a wide range of device (transistor, resistor, capacitor) properties, such as length and width. Each device type and size has transistor current-voltage curves that are generated, and a nonlinear fit is performed to find the best match of lengths and widths between the source technology and the destination technology. In brief, the analysis matches device sizes between the source technology and the target technology, so as to find similar device current-voltage characteristics in the two technologies.

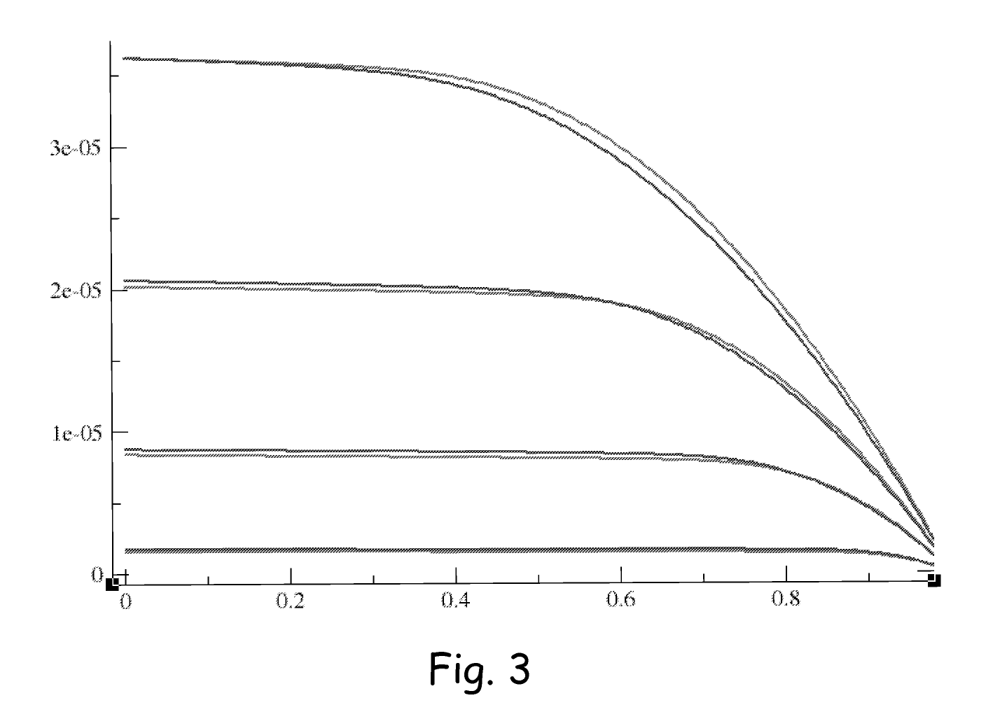

For example, the graph in FIG. 3 depicts four pairs of current-voltage curves for a PMOS transistor. One trace in each of the four pairs represents the current-voltage curve for a single gate width and length combination at a 65 nanometer node, and the second trace in each of the four pairs represents the current-voltage curve for a single gate width and length combination at a 45 nanometer node (it doesn't really matter which trace is which, as this is for illustrative purposes).

This chart was created by comparing the current-voltage curves for several different gate width and length combinations at the two different nodes, until there was found a match of within about five percent of the traces of one node with the traces of the other node. For the specific example depicted in FIG. 3, the traces for the 65 nanometer node represent a gate having a length of about 630 nanometers and a width of about one micron, and the traces for the 45 nanometer node represent a gate having a length of about 600 nanometers and a width of about 700 nanometers.

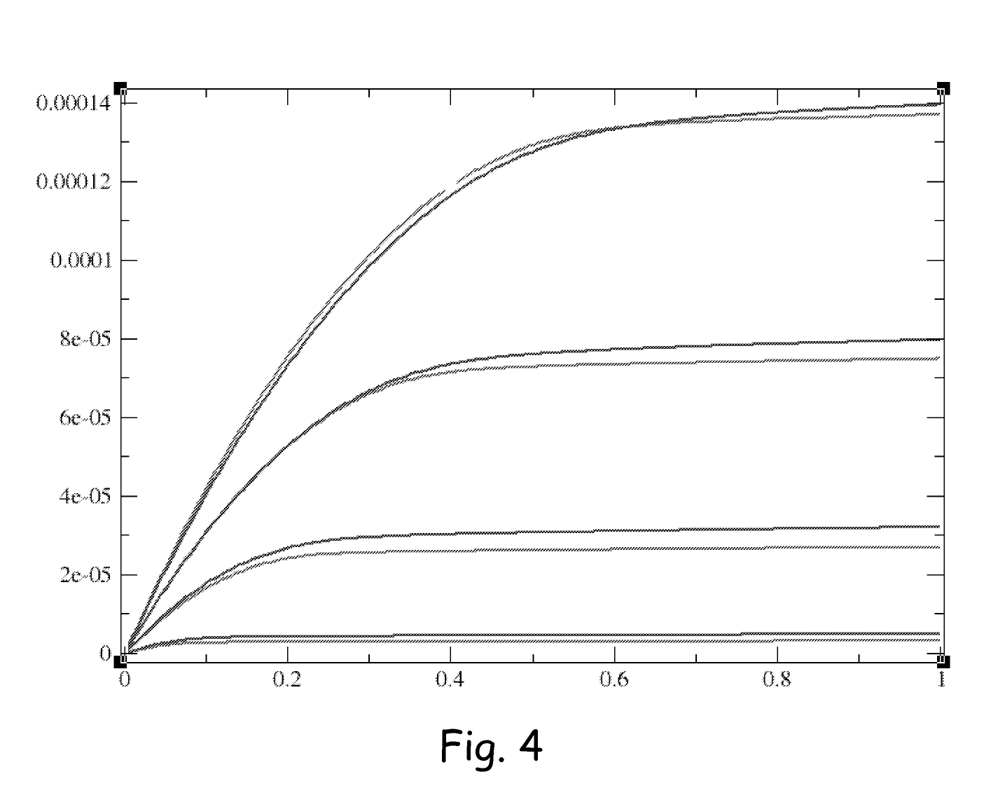

A second example of matching the current-voltage curves for an NMOS transistor between the 65 nanometer node and the 45 nanometer node is depicted in FIG. 4. In this example, the traces that match the best are a gate having a length of about 630 nanometers and a width of about one micron for the 65 nanometer node, and a gate having a length of about 600 nanometers and a width of about 850 nanometers for the 45 nanometer node.

This same process is repeated for other parameters of interest, such as current drain-to-source versus voltage drain-to-source curves (IDS-VDS), positive power voltage scaling (VDD), transconductance (Gm), output conductance (Gds), voltage threshold (Vt), delay, leakage, capacitance, and resistance. Information such as this for a variety of different parameters is selected based on the desired objective for the target technology. Suitable objectives include decreased power, increased density, and/or improving overall speed. Device parameters from the source technology are then automatically ported to the target technology after selecting the desired properties for the target device, as described in the following sections.

Once the technology transfer file is created, it can be used to port many different source circuit designs to their counterpart target circuit designs, provided that the source technology and the target technology for each port is the same. In other words, the technology transfer file is source and target technology specific, but not circuit design specific. Thus, the technology transfer file can be refined over time, such as by selecting better/different matches of specific source and target parameter combinations and adding matches for additional parameters. Therefore, the resultant technology transfer file is reusable for other ports, and can be applied for porting a wide variety of different circuit designs between the given source and target technologies. The technology transfer file is constructed, in some embodiments, using both SPICE and tcl. SPICE and tcl can also be used to analyze the technology transfer file.

### Schematic Design Routine

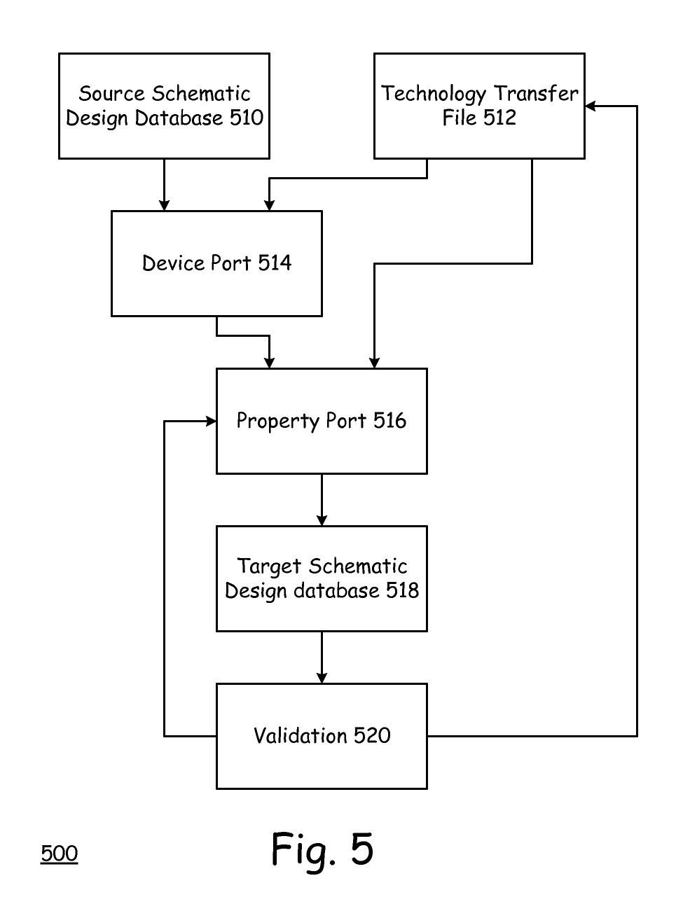

With reference now to FIG. 5, there is depicted a method 500, according to an embodiment of the present invention, for porting the schematic database for an analog circuit from the source technology to the target technology. No user intervention is required for these steps 500. The source schematic database 510 in the source process design kit is run through a first routine 514 that uses the technology transfer file 512 to change all the devices in the source design as described in the source process design kit to a description of the devices in the target process design kit.

A second routine 516 changes these new device descriptions according to the technology transfer file 512, to give each new device electrically similar characteristics to the source technology, as generally described in the technology transfer file section above. This step 516 produces a new schematic database 518 in a standard format for the target technology. Simulations 520 performed on this new circuit schematic 518 are performed, and additional tuning as required is fed back into the technology transfer file 512.

Because all of this is automated using a computer-based program and input files, and the programs can typically be executed in a matter of minutes, tuning the technology transfer file 512 and the target schematic database 518 can be accomplished in hours instead of weeks. The actual computer processing time will depend on the complexity of a given circuit. The source schematic designs 510 are ported to the target schematic designs 518, in some embodiments, using Perl and SKILL.

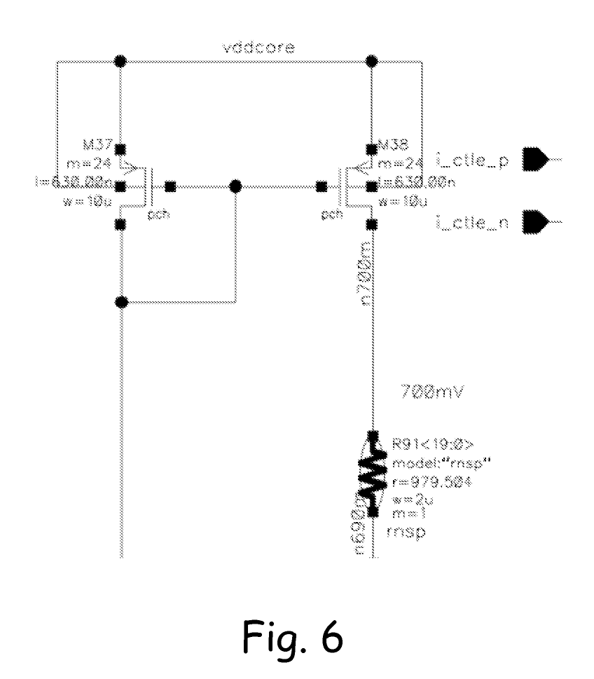

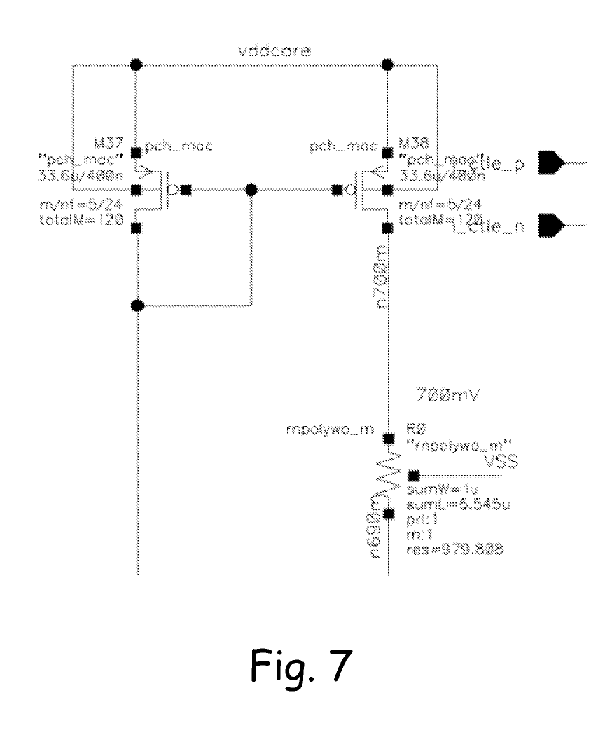

By way of example, there is depicted in FIG. 6 a source schematic diagram as constructed from a source schematic database 510 for a first technology, which in the example as depicted is a 65 nanometer node manufactured by foundry F. After running the schematic routines 514 and 516 according to an embodiment of the present invention, a target schematic database 518 is produced, which yields the target schematic diagram as depicted in FIG. 7. The specific embodiment as depicted in FIG. 7 is for a 45 nanometer node manufactured by foundry T. As can be seen, there are some differences between the circuit schematic for the source technology and the circuit schematic for the target technology, which differences will vary according to the particulars of the source and target technologies selected.

### Layout Design Routine

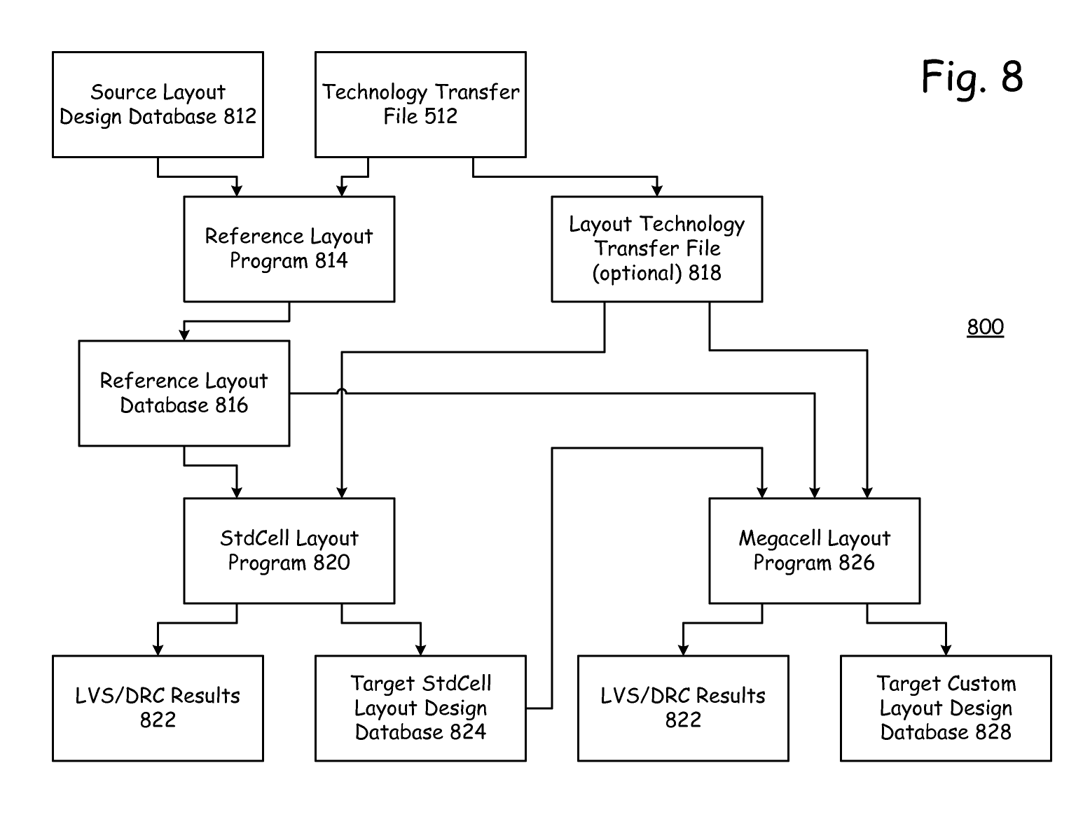

With reference now to FIG. 8, there is depicted a method 800, according to an embodiment of the present invention, for porting the layout database 812 for an analog circuit from the source technology to the target technology. No user intervention is required for these steps 800. The layout design routines 800 use the same technology transfer file 512 as used for the schematic design routine 500, plus an industry-standard file 812 that includes the layout design rules for the circuit in the source technology. The layout design routines 800 produce a target circuit design layout 824 or 828 that is typically layout verification system-clean and substantially design rule check-clean, as indicated in the results file 822. The layout routines 800 can be run in minutes, thereby giving design engineers early access to the proposed target layout 824 or 828 for post-layout extraction simulations.

The layout porting 800 can be performed based on three different methodologies: polygon, parameterized cell (Pcell), and common cell. FIG. 8 depicts the flow for common or standard cells, which incorporates the elements of both the polygon flow and the Pcell flow, and so is more instructive. The program flow for this process 800 consists of two software routines 814 and 820. The first program 814 receives as input the standard source layout 812 and the technology transfer file 512, and generates a file 816 that contains the structures for the target process design kit, together with the parameters that are required to match with the newly produced schematics 518 (from FIG. 5) to give an electrically-equivalent design.

The second program 820 receives as input these new device layout geometries 816 and information from the technology transfer file 512. However, in some embodiments the standard cell layout program 820 requires the information from the technology transfer file 512 to be in a specific format, and so that information from the technology transfer file 512 is converted into that specific format, as given in block 818.

The standard cell layout program 820 then arranges the new device layout geometries 816 to be topologically equivalent to the source design layout 812. Design rules—such as metal, contact, and via spacing and width—are also adjusted for the target technology.

In polygon-based option, the GDS layout database 812 is used directly as the input to the second program 820, and all of the layout design is manipulated at the polygon level. In the Pcell based flow, a parameterized cell 812 is manipulated in the native database (such as OA or CDS) and a GDS file 824 is generated in the target technology. In the common cell flow, common cells 824 are ported individually in the native database and then merged with a higher level of hierarchy in program 826 and ported to a GDS file 828 in the target technology.

The source layout designs 812 are ported to the target layout designs 824 or 828, in some embodiments, using Perl (for the first program 814) and a software electronic design automation tool, such as from Sagantec of Santa Clara, Calif. (for the second program 820 and 826). When this commercial program is used, then the optional modified technology transfer file 818 might be needed, so that the information in the technology transfer file 512 is presented to the second program 820 and 826 in a manner that it understands. However, if the second program 820 and 826 understands the data format of the unmodified technology transfer file 512, then no conversion to the modified technology transfer file 818 is required.

### Validation

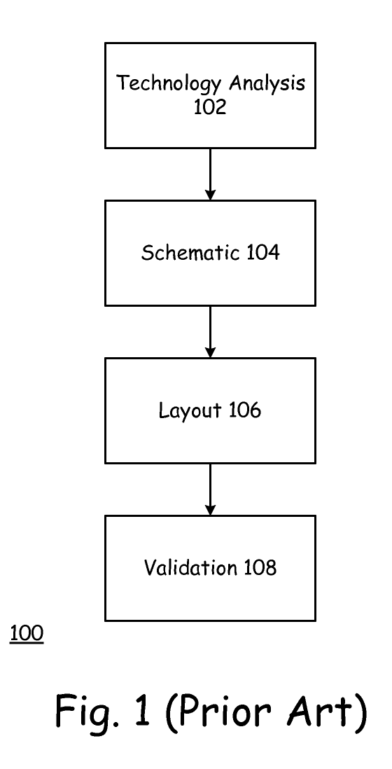

Validation, as represented by block 208 in FIG. 2 for the present invention, and by block 108 in FIG. 1 for the prior art, is substantially similar in either case. In this step, a design engineer performs a rigorous analysis of the design in the target technology to confirm that everything is properly designed and will function as desired. The engineer validates the target circuit design by determining what portion of the design needs to be redesigned, if any, in order to comply with the target specification. The target circuit design might have parameters that that are outside of the preferred specifications, such as noise immunity, voltage, swing, bandwidth, and variation sensitivity. The engineer modifies portions of the target circuit design as needed to produce the desired values for the variant parameters. Thus, it remains a labor-intensive process.

However, the difference with the new process 200 as described herein, is that the validation step is attained much faster than with the prior art process 100. Further, when problems are encountered during validation, such that revisions must be accomplished in the schematic design or the layout design (or more typically—both), the embodiments according to the present invention are able to redo those schematic and layout changes much faster, as described above.

### CONCLUSION

The various embodiments of the present invention port analog circuit designs from a source technology to a target technology while maintaining the same electrical characteristics throughout the porting process. For example, the voltage, current, input conductance, and output conductance are maintained from the source design to the target design. However, transistor dimensions, such as length and width, might be modified during the porting process, so as to meet the target technology design rule requirements. Consequently, validation time is reduced by setting electrical characteristics in the target technology to be the same as or substantially similar to the electrical characteristics in the source technology.

The various embodiments of the present invention port the source circuit design to a target circuit design that has a layout verification system-clean layout and an optical rules check-clean design. A layout verification system-clean design is one in which the layout in the target technology conforms to the required rules. In other words, the layout net list matches the schematic net list in a layout verification system-clean design. An optical rules check-clean design is one in which the target circuit design meets all of the preferred design rules desired for the target technology.

One benefit of the various embodiment of the present invention is simplicity and the short cycle time. The embodiments do not attempt to (but might) build the optimal target circuit design. However, the contemplated embodiments produce a target schematic design and a target layout design that can be quickly verified and validated.

The foregoing description of preferred embodiments for this invention has been presented for purposes of illustration and description. It is not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A computer-based method of converting an analog integrated circuit design from a source technology to a target technology, the method comprising the steps of:
providing a computer readable source schematic file and a computer readable source layout file for the analog integrated circuit design in the source technology,
providing a computer readable technology transfer file that includes conversion tables between properties of the source technology and properties of the target technology,
with the computer, converting the source schematic file in the source technology to a target schematic file in the target technology using the technology transfer file, and
with the computer, converting the source layout file in the source technology to a target layout file in the target technology using the technology transfer file.

2. The computer-based method of claim 1, wherein the step of converting the source schematic file to the target schematic file comprises:
converting source technology device names in the source schematic file to target technology device names in the target schematic file using the technology transfer file, and
converting source device properties in the source schematic file to target device properties in the target schematic file using the technology transfer file.

3. The computer-based method of claim 1, wherein the step of converting the source layout file to the target layout file comprises selectively receiving as input and providing as output one of polygon based layout files, parameterized cell based layout files, and standard cell based layout files.

4. The computer-based method of claim 1, wherein the technology transfer file comprises:
a device name conversion table for converting device names in the source technology to device names in the target technology, and
a property conversion table for converting functional device characteristics of the analog integrated circuit design in the source technology to functional device characteristics in the target technology that are associated with physical device characteristics in the target technology.

5. The computer-based method of claim 4, wherein the functional device characteristics include at least one of current drain-to-source versus voltage drain-to-source curves, positive power voltage scaling, transconductance, output conductance, voltage threshold, delay, leakage, capacitance, and resistance.

6. The computer-based method of claim 4, wherein the physical device characteristics include at least one of device length and device width.

7. The computer-based method of claim 1, wherein the source technology comprises a source node and a source foundry and the target technology comprises a target node and a target foundry, and at least one of the source node and the target node, and the source foundry and the target foundry are different between the source technology and the target technology.

8. A technology transfer file disposed on a computer-readable medium, the technology transfer file for converting an analog integrated circuit design from a source technology to a target technology, the technology transfer file comprising:
a device name conversion table for converting device names in the source technology to device names in the target technology, and
a property conversion table for converting functional device characteristics of the analog integrated circuit design in the source technology to functional device characteristics in the target technology that are associated with physical device characteristics in the target technology.

9. The technology transfer file of claim 8, wherein the source technology comprises a source node and a source foundry and the target technology comprises a target node and a target foundry, and at least one of the source node and the target node, and the source foundry and the target foundry are different between the source technology and the target technology.

10. The technology transfer file of claim 8, wherein the functional device characteristics include at least one of current drain-to-source versus voltage drain-to-source curves, positive power voltage scaling, transconductance, output conductance, voltage threshold, delay, leakage, capacitance, and resistance.

11. The technology transfer file of claim 8, wherein the physical device characteristics include at least one of device length and device width.

12. A computer-based apparatus for converting an analog integrated circuit design from a source technology to a target technology, the apparatus comprising:
an input for receiving and a memory for storing,
a source schematic file and a source layout file for the analog integrated circuit design in the source technology, and
a technology transfer file that includes conversion tables between properties of the source technology and properties of the target technology, and
logic elements for,
converting the source schematic file in the source technology to a target schematic file in the target technology using the technology transfer file, and
converting the source layout file in the source technology to a target layout file in the target technology using the technology transfer file.

13. The apparatus of claim 12, wherein the logic elements for converting the source schematic file to the target schematic file:
convert source technology device names in the source schematic file to target technology device names in the target schematic file using the technology transfer file, and
convert source device properties in the source schematic file to target device properties in the target schematic file using the technology transfer file.

14. The apparatus of claim 12, wherein the logic elements for converting the source layout file to the target layout file selectively receive as input and provide as output one of polygon based layout files, parameterized cell based layout files, and standard cell based layout files.

15. The apparatus of claim 12, wherein the technology transfer file comprises:
a device name conversion table for converting device names in the source technology to device names in the target technology, and
a property conversion table for converting functional device characteristics of the analog integrated circuit design in the source technology to functional device characteristics in the target technology that are associated with physical device characteristics in the target technology.

16. The apparatus of claim 15, wherein the functional device characteristics include at least one of current drain-to-source versus voltage drain-to-source curves, positive power voltage scaling, transconductance, output conductance, voltage threshold, delay, leakage, capacitance, and resistance.

17. The apparatus of claim 15, wherein the physical device characteristics include at least one of device length and device width.

18. The apparatus of claim 12, wherein the source technology comprises a source node and a source foundry and the target technology comprises a target node and a target foundry, and at least one of the source node and the target node, and the source foundry and the target foundry are different between the source technology and the target technology.
